(19) United States
(12) Patent Application Publication
(10) Pub. No.: US 2026/0095648 A1
(43) Pub. Date: Apr. 2, 2026

(54) INFORMATION PROCESSING DEVICE AND INFORMATION PROCESSING METHOD

(71) Applicant: Sony Group Corporation, Tokyo (JP)

(72) Inventors: Shinsuke Yonenaga, Kanagawa (JP); Ryogo Ito, Tokyo (JP); Jun Suzuki, Chiba (JP)

(73) Assignee: Sony Group Corporation, Tokyo (JP)

(21) Appl. No.: 19/108,998

(22) PCT Filed: Sep. 1, 2023
(86) PCT No.: PCT/JP2023/032083

§ 371 Date: Oct. 17, 2025

(30) Foreign Application Priority Data
Sep. 13, 2022 (JP) 2022-145442

(51) Int. Cl. H04N 23/60; H04N 23/63; H04N 23/68

(52) U.S. Cl. CPC H04N 23/64; H04N 23/631; H04N 23/6811; H04N 23/683

(57) ABSTRACT

An information processing device includes a control unit that performs control regarding provision of meta information to an image obtained by an imaging device, the meta information including at least one of phase difference information based on a signal output from a phase difference detection pixel or motion information regarding motion of the imaging device according to content of image processing to be executed on the image.

### TECHNICAL FIELD

The present technology relates to an information processing device and an information processing method, and particularly relates to a technology of providing meta information to an image.

### BACKGROUND ART

Patent Document 1 describes calculating an image displacement amount from a viewpoint image generated on the basis of pixel signals output from a plurality of sub-pixels that receives a light flux passing through a pupil partial region, calculating a conversion coefficient for converting the image displacement amount into a defocus amount, and recording in a recording medium as meta data, at least two of the conversion coefficient, the image displacement amount, and the defocus amount in association with an image.

### CITATION LIST

### Patent Document

Patent Document 1: Japanese Patent Application Laid-Open No. 2018-19348

### SUMMARY OF THE INVENTION

### Problems to be Solved by the Invention

In the technology described in Patent Document 1, various kinds of image processing can be executed using the conversion coefficient, the image displacement amount, or the defocus amount recorded as the metadata. However, if a data amount of the metadata to be added to the image is increased, there is a risk that a problem may occur that the image cannot be completely recorded in the recording medium during image capturing.

The present technology has been made in view of the above circumstances, and an object thereof is to appropriately provide meta information to an image according to image processing to be executed.

### Solutions to Problems

An information processing device according to the present technology includes a control unit that performs control regarding provision of meta information to an image obtained by an imaging device, the meta information including at least one of phase difference information based on a signal output from a phase difference detection pixel or motion information regarding motion of the imaging device, in accordance with content of image processing to be executed on the image.

As a result, the information processing device can add to the image, the meta information necessary for the image processing to be executed.

### BRIEF DESCRIPTION OF DRAWINGS

FIG. 1 is a view illustrating a configuration of a meta information provision system according to an embodiment of the present technology.

FIG. 2 is a view illustrating a configuration of an imaging device.

FIG. 3 is a block diagram illustrating an internal configuration of the imaging device and an interchangeable lens.

FIG. 4 is a view illustrating a configuration of an imaging element.

FIG. 5 is a functional block diagram of a body-side control unit.

FIG. 6 is a block diagram illustrating a configuration of a computer.

FIG. 7 is a functional block diagram of a control unit.

FIG. 8 is a view illustrating a data structure of an image obtained by the imaging device.

FIG. 9 is a view for explaining a relationship between meta information and image processing.

FIG. 10 is a view for explaining background synthesis processing.

FIG. 11 is a view for explaining the background synthesis processing.

FIG. 12 is a view for explaining the background synthesis processing.

FIG. 13 is a view for explaining focus map generation processing.

FIG. 14 is a view for explaining background blurring processing. distribution service.

FIG. 16 is a sequence chart indicating flow of the live distribution service.

FIG. 17 is a flowchart indicating flow of quality processing content determination processing.

FIG. 18 is a view illustrating an example of a UI screen.

FIG. 19 is a view for explaining priority of the image processing.

FIG. 20 is a view indicating a sequence chart of an automatic editing service.

FIG. 21 is a sequence chart indicating flow of a service for news report.

FIG. 22 is a view illustrating an example of a UI screen of a modification.

### MODE FOR CARRYING OUT THE INVENTION

Hereinafter, an embodiment will be described in the following order.
<1. Meta Information Provision System>
<2. Data Structure>
<3. Specific Examples of Image Processing>
<4. Specific Examples of Service>
<5. Meta Information Data Amount Reduction>
<6. Modifications>
<7. Summary of Embodiment>
<8. Present Technology>

Note that, in the present technology, an “image” mainly indicates a moving image, but may be a still image. Further, the “image” refers not only to a state of being displayed on a display unit, but also to image data that is not displayed on the display unit.

### 1. Meta Information Provision System

### [1.1. Configuration of Meta Information Provision System]

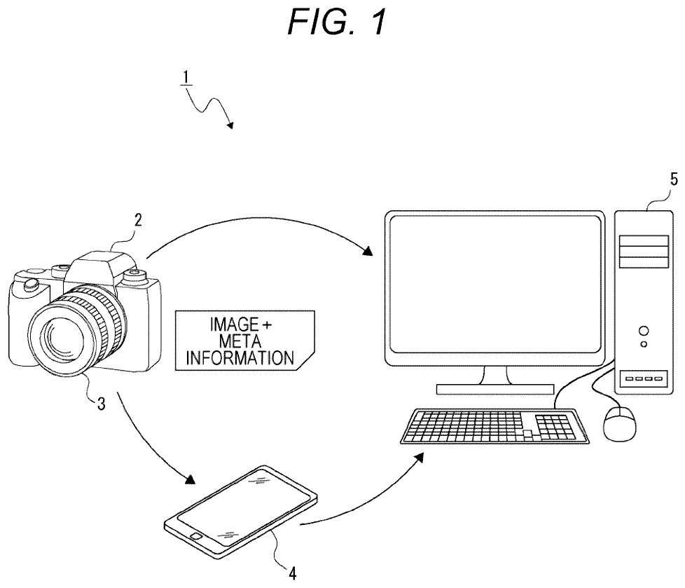

FIG. 1 is a view illustrating a configuration of a meta information provision system 1 according to an embodiment of the present technology. As illustrated in FIG. 1, the meta information provision system 1 includes an imaging device 2, a smartphone 4 and a computer 5.

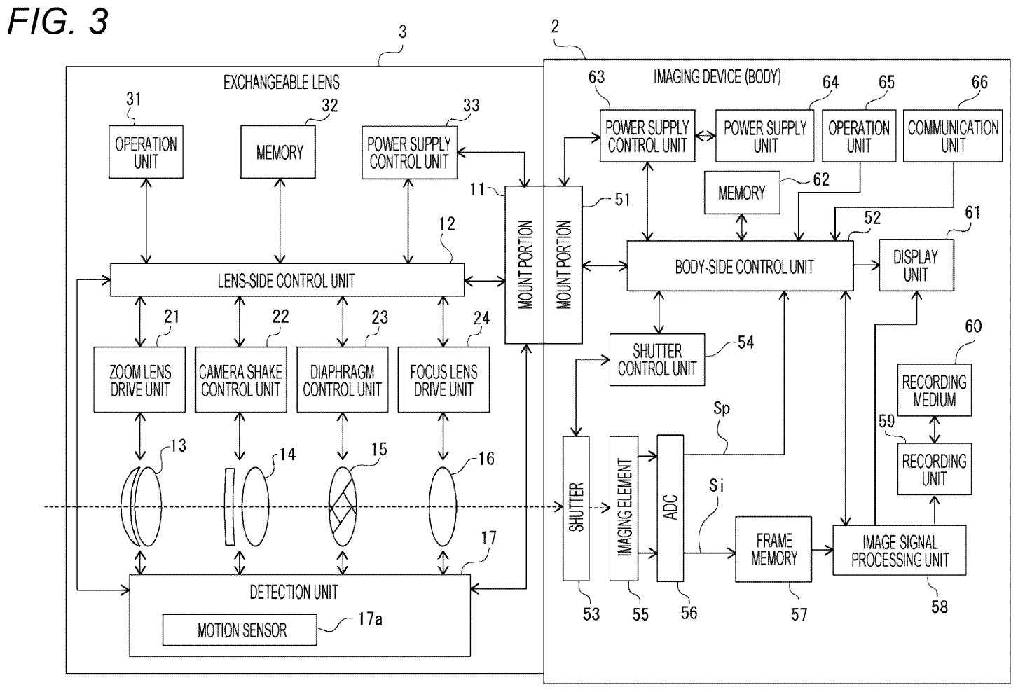

The imaging device 2 can provide meta information to an image obtained by capturing a subject image incident through an interchangeable lens 3 including a focus lens 16 (see FIG. 3).

Here, “provide” means that meta information can be made available when image processing is performed on an image. Thus, when the meta information is provided to the image, the image and the meta information may be recorded in a recording medium as one file, or the like, or may be transmitted to other devices (computer 5). Further, the image and the meta information may be recorded in different recording media (or different recording areas of the same recording medium), or may be separately transmitted to other devices (computer 5).

The smartphone 4 can communicate with the imaging device 2 and the computer 5 in a wireless or wired manner. For example, the smartphone 4 functions as a relay device when the imaging device 2 and the computer 5 communicate with each other. Thus, the imaging device 2 and the computer 5 can communicate via the smartphone 4.

The computer 5 is, for example, a personal computer, a mobile terminal device, a tablet terminal device, or the like, and can acquire an image and meta information from the imaging device 2. Note that the computer 5 may be the imaging device 2 or the smartphone 4.

Furthermore, the computer 5 may be a server, or the like, that performs cloud computing. In this case, the computer 5 acquires the image and the meta information transmitted from the imaging device 2 via the smartphone 4 via a network.

The computer 5 performs a service of executing predetermined image processing on an image and transmitting (distributing) the image subjected to the image processing to other devices on the basis of the meta information provided to the image.

Here, the “service” means provision of an image subjected to image processing to a user or an unspecified number of others. Examples of the “service” include a live distribution service for distributing an image captured by the imaging device 2 in real time, an automatic editing service for automatically editing an image captured by the imaging device 2, and a service for news report for allowing an image captured by the imaging device 2 to be used for news report.

Note that although only one computer 5 is illustrated in FIG. 1, the computer 5 may be provided for each service to be provided.

### [1.2. Configuration of Imaging Device]

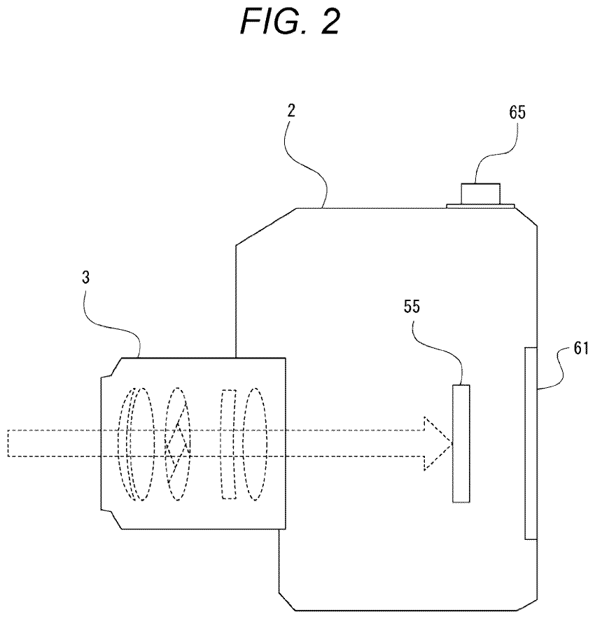

FIG. 2 is a view illustrating a configuration of the imaging device 2.

The imaging device 2 (body) is configured as a digital camera device to which the interchangeable lens 3 is detachably attached. The imaging device 2 has not only a function of capturing a still image but also a function of capturing a moving image.

As illustrated in FIG. 2, the imaging device 2 includes an imaging element 55 that captures a subject image incident via the interchangeable lens 3, a display unit 61 capable of displaying a GUI such as a captured image obtained by the imaging element 55 and various operation screens, an operation unit 65 for a user to perform various operation inputs, and the like.

Furthermore, the imaging device 2 includes, for example, a component for recording an image captured by the imaging element 55, a component for performing image signal processing on the image captured by the imaging element 55, a component for performing communication with the interchangeable lens 3, and the like.

The interchangeable lens 3 is a lens unit in which various lenses such as a focus lens and a zoom lens are provided inside. In addition, the interchangeable lens 3 includes a drive unit that drives these lenses, a control unit that outputs a drive signal to the drive unit, a mount portion having a connection function and a communication function with respect to the imaging device 2, and the like.

FIG. 3 is a block diagram illustrating an internal configuration of the imaging device 2 and the interchangeable lens 3.

As illustrated in FIG. 3, the interchangeable lens 3 includes a mount portion 11 detachably attached to the mount portion 51 of the imaging device 2. The mount portion 11 has a plurality of terminals for electrical connection with the imaging device 2.

Further, the interchangeable lens 3 includes a lens-side control unit 12, a zoom lens 13, a camera shake correction lens 14, a diaphragm 15, a focus lens 16, a detection unit 17, an operation unit 31, a memory 32, and a power supply control unit 33.

Further, the interchangeable lens 3 includes a zoom lens drive unit 21, a camera shake control unit 22, a diaphragm control unit 23, and a focus lens drive unit 24.

The lens-side control unit 12 includes, for example, a microcomputer including a central processing unit (CPU), a read only memory (ROM), a random access memory (RAM), and the like, and performs overall control of the interchangeable lens 3 by the CPU reading a program stored in a predetermined storage device such as the ROM or the memory 32 into the RAM and executing the program.

For example, the lens-side control unit 12 controls a position of the zoom lens 13 on the basis of an instruction from the imaging device 2 supplied via a predetermined communication terminal of the mount portion 11 or operation of the user received by the operation unit 31.

Specifically, the lens-side control unit 12 acquires a current position of the zoom lens 13 detected by the detection unit 17 including, for example, a magnetic sensor (MR sensor). Then, the lens-side control unit 12 determines a driving direction and a driving amount for moving the zoom lens 13 to a predetermined position on the basis of the acquisition result, and outputs the determined driving direction and driving amount to the zoom lens drive unit 21 together with a movement command.

The zoom lens drive unit 21 moves the zoom lens 13 in an optical axis direction so as to achieve the instructed driving direction and driving amount on the basis of the movement command supplied from the lens-side control unit 12.

Here, the detection unit 17 comprehensively represents a component for detecting a state of the interchangeable lens 3, such as the positions of the zoom lens 13, the camera shake correction lens 14, and the focus lens 16, and an aperture diameter of the diaphragm 15. In the detection unit 17, the positions of the lenses can be detected by, for example, a magnetic sensor, a photodiode array, a potentiometer, a reflective encoder, or the like.

Further, the detection unit 17 includes a motion sensor 17a. The motion sensor 17a detects motion of the imaging device 2. Specifically, the motion sensor 17a includes an acceleration sensor that detects accelerations in three axial directions orthogonal to each other including the optical axis direction, and a gyro sensor that detects angular velocities (pitch, yaw, roll) around the three axes.

The motion sensor 17a detects, for example, accelerations and angular velocities in synchronization with (at the same interval as) a frame constituting a moving image obtained by the imaging device 2.

The lens-side control unit 12 performs processing of transmitting the accelerations and the angular velocities detected by the motion sensor 17a to the imaging device 2 as motion information.

The lens-side control unit 12 controls camera shake correction lens 14 to correct camera shake. Specifically, on the basis of a motion amount (camera shake amount) of the imaging device 2 detected by the motion sensor 17a, the lens-side control unit 12 determines a driving direction and a driving amount of the camera shake correction lens 14 in a direction to cancel the camera shake amount, and outputs the determined driving direction and driving amount together with a movement command to the camera shake control unit 22.

The camera shake control unit 22 moves the camera shake correction lens 14 in the instructed driving direction and driving amount on the basis of the movement command supplied from the lens-side control unit 12.

Further, in a case where power supply is turned off, the lens-side control unit 12 performs control to mechanically lock the camera shake correction lens 14. In a state where power is supplied from the imaging device 2 to the interchangeable lens 3, a position of the camera shake correction lens 14 is maintained at a predetermined position by control via the camera shake control unit 22. On the other hand, if the power supply is turned off, the position control by the camera shake control unit 22 is stopped, so that the camera shake correction lens 14 falls by a predetermined amount in a gravity direction.

Thus, the lens-side control unit 12 mechanically locks the camera shake correction lens 14 via the camera shake control unit 22 according to a timing at which the power supply is turned off, thereby preventing the camera shake correction lens 14 from falling. The camera shake control unit 22 mechanically locks the camera shake correction lens 14 on the basis of a fixing command supplied from the lens-side control unit 12.

Furthermore, the lens-side control unit 12 controls (an aperture diameter of) the diaphragm 15 in accordance with an instruction, or the like, from the imaging device 2 supplied via a predetermined communication terminal of the mount portion 11. Specifically, the lens-side control unit 12 acquires the aperture diameter of the diaphragm 15 detected by the diaphragm detection sensor in the detection unit 17, issues a command to the diaphragm control unit 23 so as to achieve an F value instructed by the imaging device 2, and drives the diaphragm 15. The diaphragm control unit 23 drives the diaphragm 15 to have the aperture diameter instructed from the lens-side control unit 12.

Furthermore, the lens-side control unit 12 controls the position of the focus lens 16 on the basis of an instruction from the imaging device 2 supplied via a predetermined communication terminal of the mount portion 11.

Here, for example, in auto focus (AF) processing, a target position of the focus lens is instructed from the imaging device 2 to the lens-side control unit 12.

The lens-side control unit 12 acquires the current position of the focus lens 16 from the detection unit 17, and determines a driving direction and a driving amount for moving the focus lens 16 to the target position on the basis of the acquired current position and the target position of the focus lens instructed from the imaging device 2. Then, the lens-side control unit 12 outputs the determined driving direction and driving amount to the focus lens drive unit 24 together with the movement command.

The focus lens drive unit 24 moves the focus lens 16 in the optical axis direction so as to achieve the instructed driving direction and driving amount.

Here, the focus lens 16 is configured as a “focus lens group” including one or a plurality of optical elements. In a case where the focus lens group includes a plurality of optical elements, the optical elements are integrally displaced in accordance with focus adjustment.

Note that this similarly applies to the zoom lens 13. In other words, the zoom lens 13 is configured as a “zoom lens group” including one or a plurality of optical elements, and in a case where the zoom lens group includes a plurality of optical elements, the optical elements are integrally displaced in accordance with zoom adjustment.

In this example, the zoom lens 13 and the focus lens 16 are respectively configured as one zoom lens group and one focus lens group. However, the zoom lens 13 and the focus lens 16 may be respectively configured as a plurality of zoom lens groups and a plurality of focus lens groups.

The focus lens drive unit 24 can include, for example, an ultrasonic motor, a DC motor, a linear actuator, a stepping motor, a piezo element (piezoelectric element), and the like, as a drive source of the lens.

Note that the focus adjustment can be configured to be performed according to the operation of the user received by the operation unit 31.

The memory 32 is constituted with a non-volatile memory such as an electrically erasable programmable (EEP), for example, and can be used to store an operation program of the lens-side control unit 12 and various kinds of data.

The power supply control unit 33 detects an amount of power of a power supply supplied from the imaging device 2, optimally distributes the amount of power to respective units (the lens-side control unit 12 and various drive units) in the interchangeable lens 3 on the basis of the detected amount of power, and supplies the power.

The imaging device 2 that is on the body side is provided with the mount portion 51 to which the interchangeable lens 3 is detachably attached. The mount portion 51 has a plurality of terminals for electrical connection with the mount portion 11 of the interchangeable lens 3.

If the interchangeable lens 3 is mounted on the mount portion 51 of the imaging device 2, the corresponding terminals are electrically and physically connected between the mount portion 51 and the mount portion 11 of the interchangeable lens 3. Examples of the terminals to be connected include a terminal for supplying power (power supply terminal), a terminal for transmitting a command or data (communication terminal), and a terminal for transmitting a synchronization signal (synchronization signal terminal).

The imaging device 2 further includes a body-side control unit 52, a shutter 53, a shutter control unit 54, an imaging element 55, an analog to digital converter (ADC) 56, a frame memory 57, an image signal processing unit 58, a recording unit 59, a recording medium 60, a display unit 61, a memory 62, a power supply control unit 63, a power supply unit 64, an operation unit 65, and a communication unit 66.

The power supply control unit 63 supplies the power supplied from the power supply unit 64 to each unit of the imaging device 2 including the body-side control unit 52. Furthermore, the power supply control unit 63 calculates an amount of power of the power supply that can be supplied to the interchangeable lens 3 on the basis of an operation state of the imaging device 2, and supplies power to the interchangeable lens 3 via the mount portion 51.

The power supply unit 64 includes, for example, a secondary battery such as a NiCd battery, a NiMH battery, or a Li battery. Note that the power supply unit 64 can also be configured to be able to receive power supply from a commercial AC power supply via an AC adapter, or the like.

The body-side control unit 52 includes a and performs overall control of the imaging device 2 and the interchangeable lens 3 by the CPU reading a program stored in a predetermined storage device such as the ROM or the memory 62 into the RAM and executing the program.

The memory 62 is constituted with a non-volatile memory such as an EEPROM, for example, and can be used for storing an operation program of the body-side control unit 52 and various kinds of data.

The body-side control unit 52 causes the imaging element 55 to execute imaging processing on the basis of an operation signal indicating operation of the user supplied from the operation unit 65. Further, a predetermined command is transmitted to the interchangeable lens 3 side via the mount portion 51, and the focus lens 16, the zoom lens 13, and the like, are driven.

The shutter 53 is disposed on the front surface (subject side) of the imaging element 55, and is opened and closed under the control of the shutter control unit 54. When the shutter 53 is in a closed state, light of the subject passing through an optical system of the interchangeable lens 3 is blocked. The shutter control unit 54 detects an open/closed state of the shutter 53 and supplies information indicating a detection result to the body-side control unit 52. The shutter control unit 54 drives the shutter 53 to the open state or the closed state on the basis of the control of the body-side control unit 52.

The imaging element 55 is configured as, for example, an image sensor including a charge coupled device (CCD) sensor, a complementary metal oxide semiconductor (CMOS) sensor, or the like, and outputs a light reception signal obtained by imaging a subject.

In a case where the imaging element 55 includes a CCD sensor or a CMOS sensor, an electronic shutter can be used, and thus, the shutter 53 can be omitted. In a case where the shutter 53 is omitted, the shutter control unit 54 that is to be used for the control is also omitted.

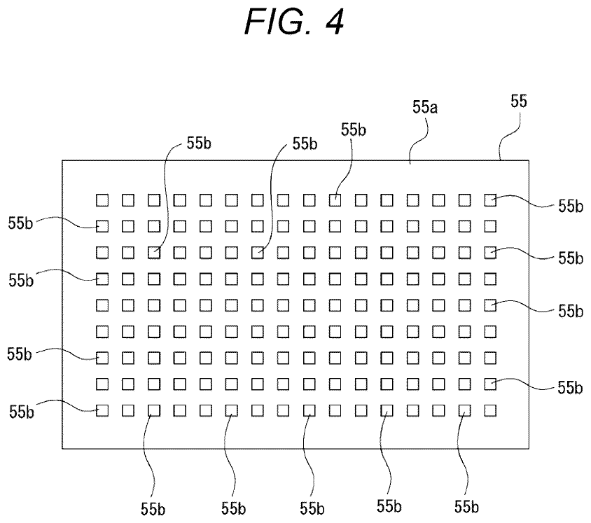

FIG. 4 is a view illustrating a configuration of the imaging element 55. Note that, in FIG. 4, for convenience of description, individual illustration of the RGB pixel 55a is omitted.

As illustrated in FIG. 4, the imaging element 55 includes a pixel (RGB pixel) 55a for capturing an image, and a pixel for acquiring detection information to be used for AF processing by an image-plane phase difference method, that is, a phase difference detection pixel 55b that includes a pair of photoelectric conversion units (diodes) on which pupil-divided light is incident within one pixel and detects a phase difference between a pair of images generated by the pair of photoelectric conversion units.

In the imaging element 55, the RGB pixels 55a are two-dimensionally arrayed in a horizontal direction and a vertical direction (in the drawing, a horizontal direction and a vertical direction) in a predetermined array pattern such as a Bayer array, for example. In the imaging element 55, the phase difference detection pixels 55b are discretely arranged in the horizontal direction and the vertical direction on a pixel array surface on which the RGB pixels 55a are two-dimensionally arrayed.

The light reception signal obtained by the photoelectric conversion of the RGB pixel 55a in the imaging element 55 is converted into a digital signal by the ADC 56, temporarily held in the frame memory 57, and then input to the image signal processing unit 58.

In FIG. 3, the captured image signal obtained by digitally converting the light reception signal of the RGB pixel 55a as described above is referred to as a “captured image signal Si”.

On the other hand, a light reception signal obtained by photoelectric conversion of the phase difference detection pixel 55b in the imaging element 55 is converted into a digital signal by the ADC 56 and supplied to the body-side control unit 52.

In FIG. 3, the signal obtained by digitally converting the light reception signal of the phase difference detection pixel 55b in this manner is referred to as a “phase difference pixel signal Sp”.

The body-side control unit 52 detects a phase difference (phase shift amount) between a pair of images on the basis of the phase difference pixel signal Sp supplied via the ADC 56, thereby calculating a focus shift amount for each phase difference detection pixel 55b, that is, a defocus amount as phase difference information. An existing method can be used as a method of calculating the defocus amount, and thus, detailed description thereof will be omitted.

The body-side control unit 52 can perform the AF processing on the basis of the phase difference information calculated in this manner. In the phase difference detection pixel 55b, for example, the light reception signal is obtained in synchronization with the RGB pixel 55a. In other words, the body-side control unit 52 calculates the phase difference information in synchronization with (at the same interval as) a frame constituting the moving image obtained by the imaging device 2.

The image signal processing unit 58 performs predetermined image signal processing on the captured image based on the captured image signal Si input via the frame memory 57. Here, examples of the image signal processing include demosaic processing, white balance (WB) adjustment, gamma correction processing, and the like.

The image signal processing unit 58 performs image signal processing on the captured image as a RAW image input via the frame memory 57, then converts the captured image into a predetermined file format, and causes the captured image to be recorded in the recording medium 60 via the recording unit 59.

In this event, as will be described in detail later, the body-side control unit 52 provides meta information to the image recorded in the recording medium 60.

Furthermore, the image signal processing unit 58 supplies the image subjected to the image signal processing to the display unit 61, and causes the display unit 61 to display the captured image.

The recording mediuem 60 includes a non-volatile memory, and the recording unit 59 is configured to be able to write data to the recording medium 60 and read data recorded in the recording medium 60. Here, the recording medium 60 may be detachable from the imaging device 2.

The display unit 61 includes a display device such as a liquid crystal display or an organic EL display, and can display an image.

The display unit 61 is mounted on a back surface opposite to the front surface of the imaging device 2 on which the mount portion 51 is disposed, and can perform display of a so-called through image, display of an image read from the recording medium 60, display of a GUI as various operation screens, and the like.

The operation unit 65 comprehensively represents an operator for allowing the user to perform operation input to the imaging device 2, such as various hardware keys such as a shutter button, a mode dial, and a zoom button, and a touch panel provided to be able to detect touch operation on a display screen of the display unit 61.

The operation unit 65 accepts the operation of the user and supplies an operation signal in accordance with the operation to the body-side control unit 52.

The communication unit 66 performs communication with the smartphone 4, for example, in a wired or wireless manner. Note that the communication unit 66 may directly perform communication with the computer 5 in a wired or wireless manner without using the smartphone 4.

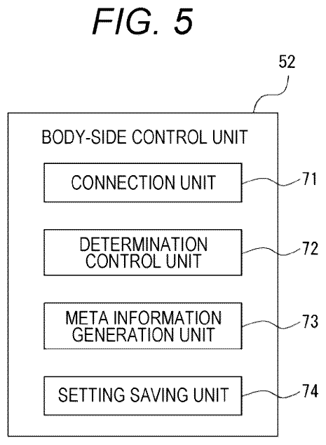

FIG. 5 is a functional block diagram of the body-side control unit 52. As illustrated in FIG. 5, the body-side control unit 52 includes functional units as a connection unit 71, a determination control unit 72, a meta information generation unit 73, and a setting saving unit 74.

The connection unit 71 performs processing regarding communication with the computer 5 via the smartphone 4. For example, the connection unit 71 establishes a network connection with the computer 5 via the smartphone 4, and transmits an image and meta information to the computer 5.

The determination control unit 72 determines image quality (bit rate) and content of image processing to be executed by the service. In addition, the determination control unit 72 performs control regarding provision of the meta information according to the determined image quality and the content of the image processing to be executed in the service. Note that, although a specific example will be described later in detail, the control regarding provision of the meta information includes determining at least one of a type of the meta information, a provision frequency of the meta information, a provision timing of the meta information, a format of the meta information, or the like.

The meta information generation unit 73 generates meta information according to the determination made by the determination control unit 72.

The setting saving unit 74 saves the image quality determined by the determination control unit 72 and the meta information to be provided to the image data in the memory 62.

Note that the connection unit 71, the determination control unit 72, the meta information generation unit 73, and the setting saving unit 74 will be described later in detail.

### [1.3. Configuration of Computer]

Next, the computer 5 that performs various services on the basis of the image and the meta information acquired by the imaging device 2 will be described.

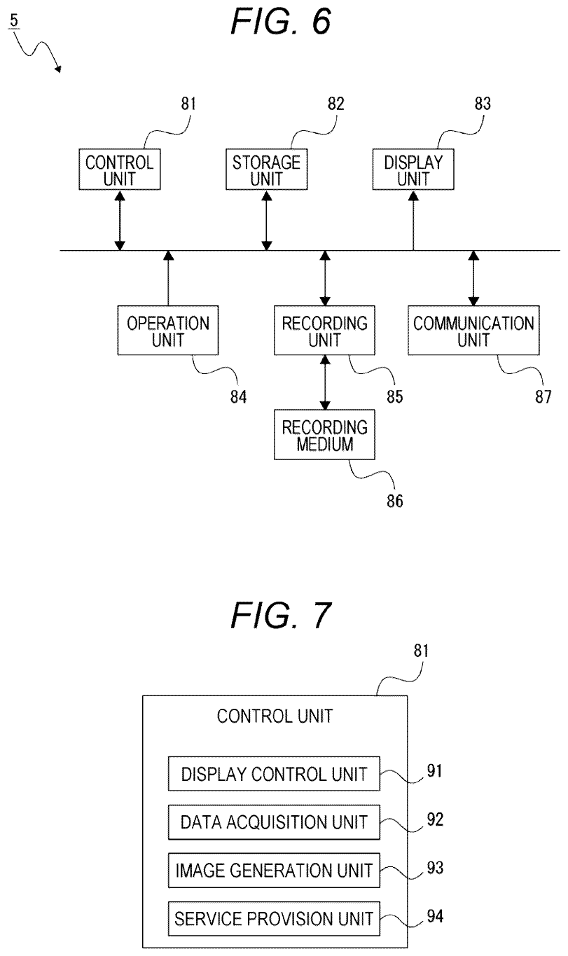

FIG. 6 is a block diagram illustrating a configuration of the computer 5. As illustrated in FIG. 6, the computer 5 includes a control unit 81, a storage unit 82, a display unit 83, an operation unit 84, a recording unit 85, a recording medium 86, and a communication unit 87.

The control unit 81 includes, for example, a microcomputer including a CPU, a ROM, a RAM, and the like, and performs overall control of the computer 5 by the CPU reading a program stored in a predetermined storage device such as the ROM or the storage unit 82 into the RAM and executing the program.

The storage unit 82 includes, for example, a storage medium such as a solid-state memory. The storage unit 82 can store, for example, various kinds of information. Furthermore, the storage unit 82 can also be used to store program data for the control unit 81 to execute various kinds of processing.

The display unit 83 is a liquid crystal display, an organic EL display, or the like, and displays various images.

The operation unit 84 is an input device to be used by the user, and is, for example, various operators and operation devices such as a keyboard, a mouse, a button, a dial, a touch pad, and a touch panel. If the operation of the user is detected by the operation unit 84, a signal corresponding to the input operation is transmitted to the control unit 81.

The recording medium 86 includes a non-volatile memory, and the recording unit 85 is configured to be able to write data to the recording medium 86 and read data recorded in the recording medium 86. Here, the recording medium 86 may be detachable from the computer 5.

The communication unit 87 performs communication with the imaging device 2 via the smartphone 4 in a wired or wireless manner. Note that the communication unit 87 may directly perform communication with the imaging device 2 in a wired or wireless manner without using the smartphone 4.

FIG. 7 is a functional block diagram of the control unit 81. As illustrated in FIG. 7, the control unit 81 includes functional units as a display control unit 91, a data acquisition unit 92, an image generation unit 93, and a service provision unit 94.

The display control unit 91 generates a UI screen to be displayed on the display unit 61 of the imaging device 2 or the display unit of the smartphone 4. Then, the display control unit 91 transmits the generated UI screen to the imaging device 2 or the smartphone 4 to display the UI screen on the display unit 61 of the imaging device 2 or the display unit of the smartphone 4. On this UI screen, as will be described in detail later, it is possible to determine the image quality and the content of the image processing.

The data acquisition unit 92 acquires the image and the meta information transmitted from the imaging device 2. In a case where the recording medium 60 of the imaging device 2 is loaded to the computer 5 as the recording medium 86, the data acquisition unit 92 acquires the image and the meta information from the recording medium 86 via the recording unit 85. Furthermore, the data acquisition unit 92 acquires the image and the meta information by communicating with the imaging device 2 via the communication unit 87.

The image generation unit 93 executes image processing according to a service to be provided on the basis of the meta information provided to the image.

The service provision unit 94 provides the image subjected to the image processing by the image generation unit 93 according to the service.

Note that the display control unit 91, the data acquisition unit 92, the image generation unit 93, and the service provision unit 94 will be described later in detail.

### 2. Data Structure

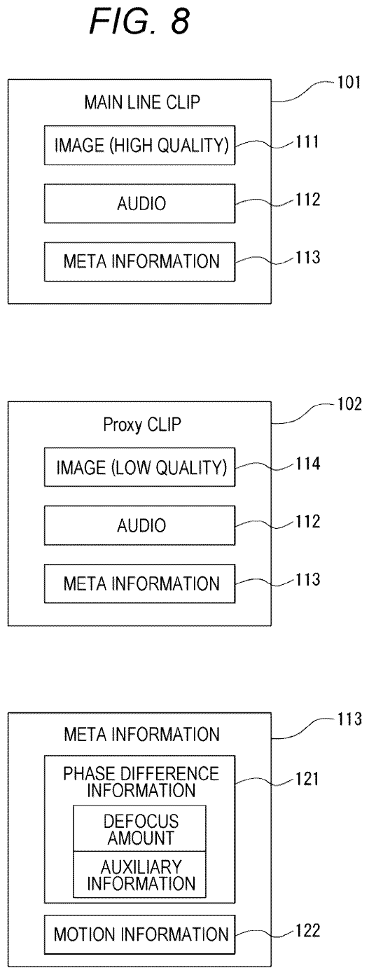

FIG. 8 is a view for explaining a data structure of an image (moving image) obtained by the imaging device 2. As illustrated in FIG. 8, in the imaging device 2, in a case where a moving image is captured, a main line clip 101 including an image 111 with image quality (high quality) determined by the determination control unit 72 is generated.

Furthermore, in the imaging device 2, in addition to the main line clip 101, a proxy clip 102 including an image 114 with a lower bit rate (lower quality) than the image 111 can be generated.

Common audio data 112 and meta information 113 are added to the main line clip 101 and the proxy clip 102.

The meta information 113 can include phase difference information 121 based on the detection result of the phase difference detection pixel 55b and motion information 122 based on the detection result of the motion sensor 17a.

The meta information 113 may include one or both of the phase difference information 121 and the motion information 122 or does not have to include both of them according to content of a service and image processing to be described later.

Furthermore, the phase difference information 121 includes a defocus amount for each phase difference detection pixel 55b, and may include, in addition to the defocus amount, auxiliary information to be used when the defocus amount is calculated. Note that in a case where the phase difference information 121 includes the defocus amount and the auxiliary information, it may be referred to as full phase difference information, and in a case where the phase difference information 121 includes only the defocus amount and the auxiliary information is excluded, it may be referred to as light phase difference information.

A data amount of the full phase difference information is larger than that of the light phase difference information by an amount of the auxiliary information included.

As described above, in the imaging device 2, at least the main line clip 101 is generated when a moving image is captured, but it is possible to generate the proxy clip 102 together with the main line clip 101.

Note that, in the following description, description will be provided while audio having a low data amount (bit rate) is not taken into account.

### 3. Specific Examples of Image Processing

Next, image processing to be performed by the computer 5 using one or both of the phase difference information and the motion information included in the meta information will be described.

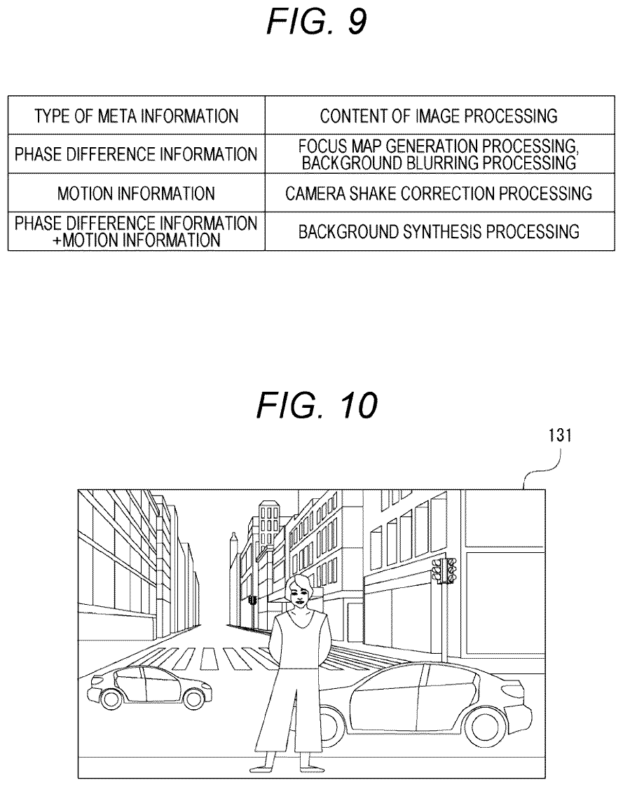

FIG. 9 is a view for explaining a relationship between the meta information and the image processing. As illustrated in FIG. 9, examples of the image processing to be performed by the computer 5 include focus map generation processing, background blurring processing, camera shake correction processing, background synthesis processing, and the like. Note that these are merely examples, and in the computer 5, other kinds of image processing may be performed as the image processing using the phase difference information or the motion information, or some kinds of image processing do not have to be performed.

Further, the phase difference information is used in the focus map generation processing and the background blurring processing. Still further, the motion information is used in the camera shake correction processing. Further, the phase difference information and the motion information are used in the background synthesis processing.

Note that the phase difference information to be used here may be the full phase difference information or the light phase difference information, but the image processing can be performed more accurately in a case where the full phase difference information is used than in a case where the light phase difference information is used.

### [3.1. Background Synthesis Processing]

FIGS. 10 to 12 are views for explaining the background synthesis processing. For example, it is assumed that an image 131 illustrated in FIG. 10 is obtained by the imaging device 2. The phase difference information and the motion information are provided to the image 131 as the meta information.

The phase difference information indicates a defocus amount at a position corresponding to the phase difference detection pixel 55b.

Thus, the image generation unit 93 calculates a defocus amount for each subject in the image 131 on the basis of the phase difference information. Note that the image generation unit 93 extracts a subject from the image using an existing technology.

Then, the image generation unit 93 extracts only a subject having a defocus amount equal to or less than a predetermined value (a person in the drawing), that is, a subject in focus.

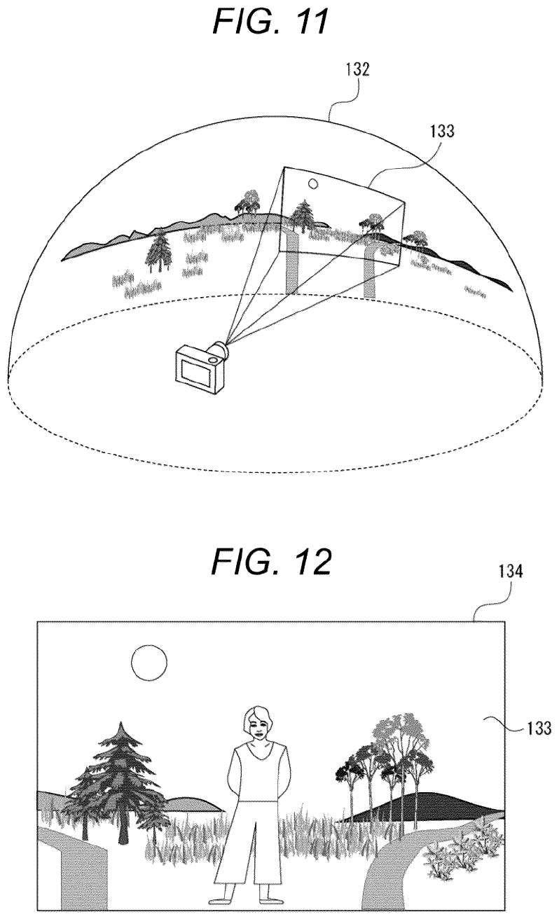

Furthermore, as illustrated in FIG. 11, the image generation unit 93 extracts an image portion 133 to be synthesized as a background on the basis of the motion information from a three-dimensional virtual image 132 of a half celestial sphere stored in advance in the storage unit 82 or the recording unit 85. Specifically, the image generation unit 93 estimates a position and a posture of the imaging device 2 when the image is obtained by the imaging device 2 on the basis of the motion information. Then, the image portion 133 in a direction indicated by the estimated position and posture is extracted.

Thereafter, as illustrated in FIG. 12, the image generation unit 93 generates a background synthetic image 134 in which the subject extracted from the image 131 is synthesized on the extracted image portion 133.

The image generation unit 93 generates a background synthetic image 134 for each frame. As a result, the background synthetic image 134 in which the background (image portion 133) is moved in accordance with movement of the imaging device 2 can be generated as a moving image.

### [3.2. Focus Map Generation Processing]

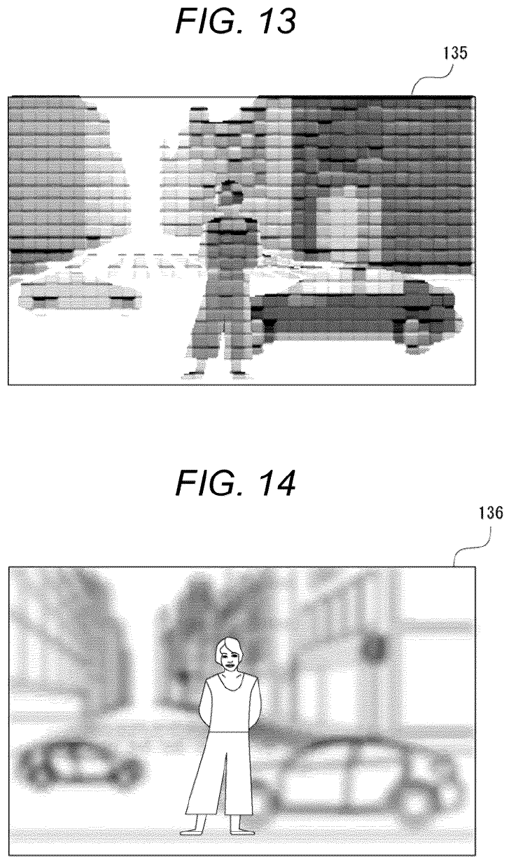

FIG. 13 is a view for explaining the focus map generation processing. For example, it is assumed that an image 131 illustrated in FIG. 10 is obtained by the imaging device 2. The phase difference information is provided to the image 131 as the meta information.

Then, the phase difference information indicates a defocus amount at a position corresponding to the phase difference detection pixel 55b.

Thus, as illustrated in FIG. 13, on the basis of the phase difference information, the image generation unit 93 generates a focus map 135 color-coded with different colors according to the defocus amount for each region corresponding to the position of the phase difference detection pixel 55b in the image.

The image generation unit 93 generates a focus map 135 for each frame. As a result, by the user confirming the focus map 135, it is possible to allow the user to easily grasp blur for each region in the moving image, which position is focused, and the like.

### [3.3. Camera Shake Correction Processing]

When the camera shake correction is executed, the motion information is provided to the image as the meta information. The motion information includes accelerations of three axes detected by the motion sensor 17a and angular velocities around the three axes.

Thus, the image generation unit 93 calculates motion (direction and movement amount) of the imaging device 2 on the basis of the accelerations of the three axes of the imaging device 2 detected by the motion sensor 17a and the angular velocities around the three axes. Then, the image generation unit 93 crops the image for each frame according to the calculated motion of the imaging device 2, thereby generating a moving image with reduced camera shake.

### [3.4. Background Blurring Processing]

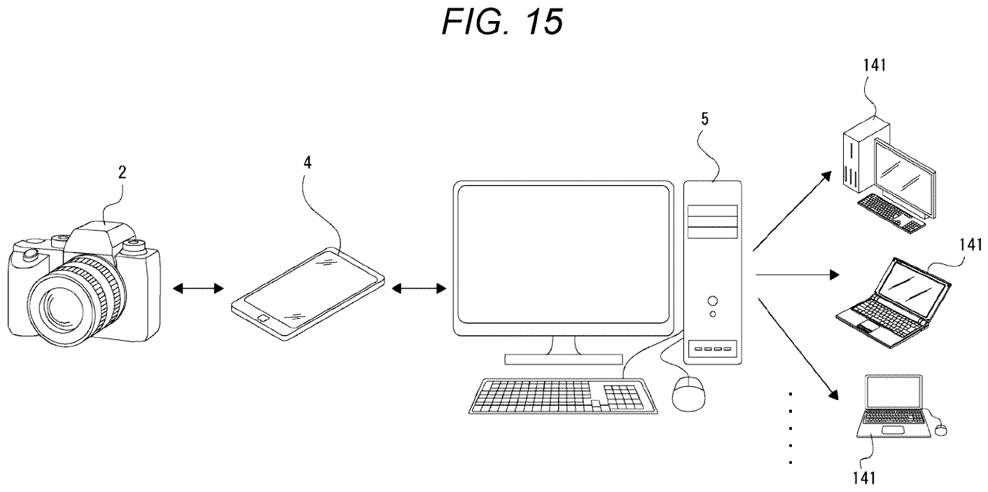

FIG. 14 is a view for explaining the background blurring processing. For example, it is assumed that an image 131 illustrated in FIG. 10 is obtained by the imaging device 2. The phase difference information is provided to the image 131 as the meta information.

Then, the phase difference information indicates a defocus amount at a position corresponding to the phase difference detection pixel 55b.

Thus, the image generation unit 93 calculates a defocus amount for each subject in the image 131 on the basis of the phase difference information. Then, the image generation unit 93 performs predetermined blurring processing on a subject (person in the drawing) having a defocus amount equal to or less than a predetermined value, that is, a subject in focus as it is, and generates a background blurred image 136 illustrated in FIG. 14.

The image generation unit 93 generates the background blurred image 136 for each frame. As a result, it is possible to generate a moving image in which the subject in focus appears more clearly and the background is blurred. This is a moving image to be used for news report, or the like, and is particularly useful for protecting privacy of a person appearing as a background.

### 4. Specific Examples of Service

Next, a service to be provided by the meta information provision system 1 will be described with specific examples. Here, a live distribution service, an automatic editing service, and a broadcast service will be described as an example.

### [4.1. Live Distribution Service]

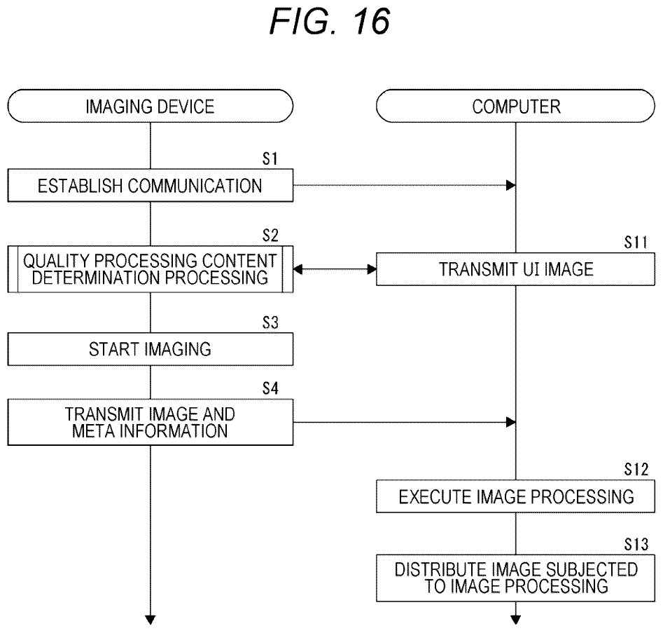

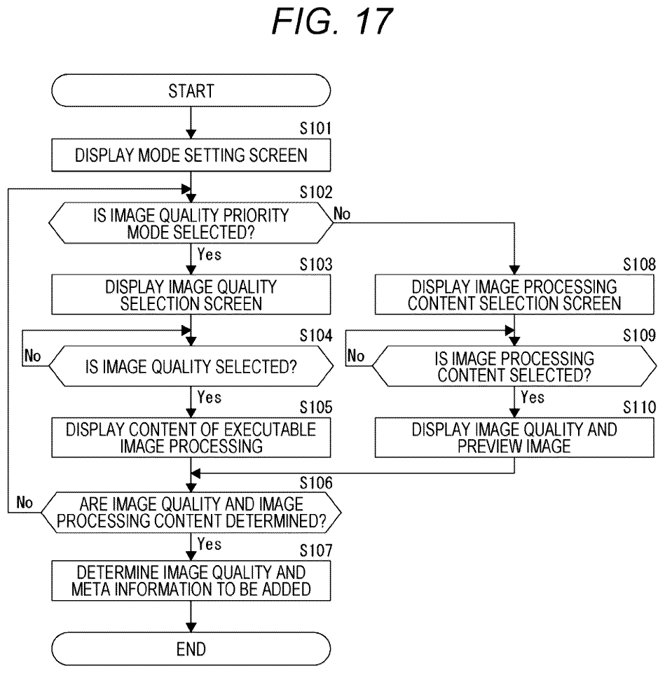

FIG. 15 is a view for explaining outline of the live distribution service. FIG. 16 is a sequence chart indicating flow of the live distribution service. FIG. 17 is a flowchart indicating flow in quality processing content determination processing.

As illustrated in FIG. 15, in the live distribution service, an image and meta information captured by the imaging device 2 are transmitted to the computer 5 via the smartphone 4. Then, in the computer 5, the image processing is executed on the received image on the basis of the meta information, and the image subjected to the image processing is distributed to an unspecified number of devices 141 in real time. In other words, the live distribution service is a service in which the computer 5 performs image processing on the image captured by the imaging device 2 and distributes the image subjected to the image processing in real time.

Note that, as the image processing in the live distribution service, background synthesis processing, image shake correction processing, and focus map generation processing can be executed. Further, in the live distribution service, only the main line clip (the image and the meta information) is recorded.

First, for example, if the live distribution service is started according to the operation on the operation unit 31 of the imaging device 2, as illustrated in FIG. 16, the connection unit 71 of the imaging device 2 performs account authentication, or the like, on the computer 5 that performs the live distribution service, and establishes communication via the smartphone 4 (step S1).

Further, the connection unit 71 transmits the meta information that can be acquired by the imaging device 2 to the computer 5. Here, for example, information indicating whether or not the phase difference information and the motion information can be acquired is transmitted to the computer 5.

In the computer 5, the display control unit 91 generates a UI screen to be displayed on the display unit 61 of the imaging device 2 or the display unit of the smartphone 4, and transmits data of the generated UI screen to the imaging device 2 or the smartphone 4 (step S11). Note that a case where data of a UI image is transmitted to the imaging device 2 will be described below.

If the imaging device 2 receives the data of the UI screen, the imaging device 2 displays the UI screen on the basis of the data. Then, the determination control unit 72 performs quality processing content determination processing of determining image quality (bit rate), content of image processing, and the like, according to operation of the user on the UI screen (step S2).

Note that the UI screen is constituted by one or a plurality of screens, and one or a plurality of screens are switched and displayed in accordance with the operation of the user, and during this time, content corresponding to the operation of the user are mutually communicated between the imaging device 2 and the computer 5.

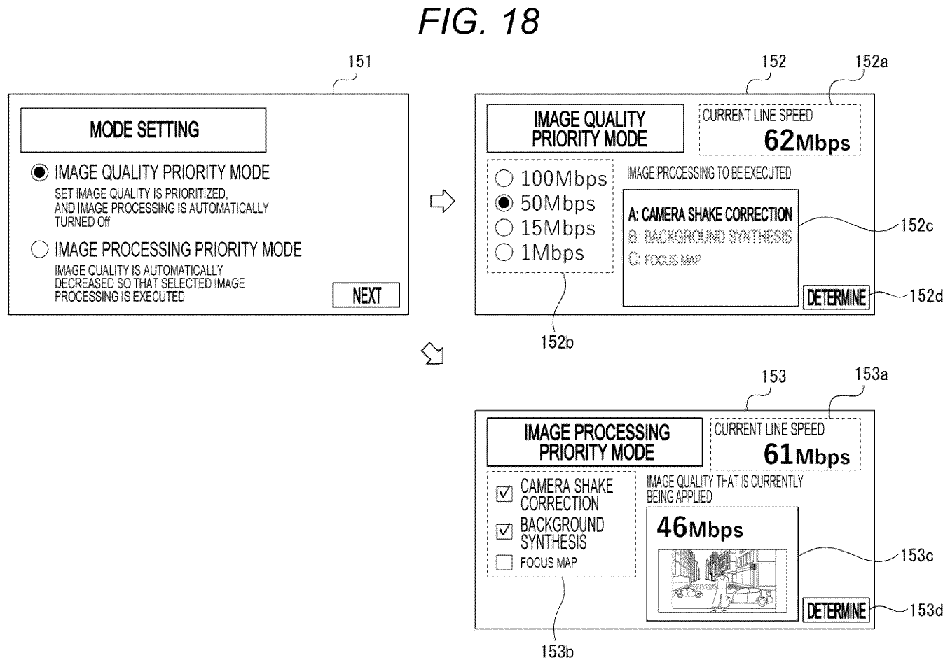

FIG. 18 is a view illustrating an example of the UI screen. First, in the imaging device 2, as illustrated in FIG. 18, a mode setting screen 151 on the UI screen is displayed on the display unit 61 (step S101 in FIG. 17). On the mode setting screen 151, a radio button (option button) for selecting an image quality priority mode or an image processing priority mode is displayed.

Here, the image quality priority mode is a mode in which the image quality is prioritized over the image processing, and is a mode in which the image quality is not degraded even if the meta information to be added is reduced (even if the image processing is not performed) when a line speed is low.

The image processing priority mode is a mode in which the image processing is prioritized over the image quality, and is a mode in which the meta information to be added is not reduced (the image processing is performed) even if the image quality is degraded when the line speed is low.

Then, if the “image quality priority mode” is selected and determined via the operation unit 65 (step S102: Yes), the connection unit 71 transmits information indicating the selection and determination to the computer 5. In the computer 5, the display control unit 91 generates an image quality priority image 152 and transmits data of the image quality priority image 152 to the imaging device 2. As a result, in the imaging device 2, the image quality priority image 152 is displayed on the display unit 61 (step S103).

The image quality priority image 152 is provided with a line speed display area 152a for displaying a current line speed, a quality selection area 152b for selecting image quality, and an image processing content display area 152c for displaying content of executable image processing.

The computer 5 measures the line speed from the imaging device 2 to the computer 5 by receiving a predetermined amount of data from the imaging device 2 at predetermined intervals and measuring a period for receiving the data. Then, the display control unit 91 displays the measured line speed (“62 Mbps” in the drawing) in the line speed display area 152a. This allows the user to confirm the current line speed in real time.

In the quality selection area 152b, selection candidates of the image quality are displayed, and a radio button for selecting one of the selection candidates is displayed. As the selection candidates of the image quality, for example, “100 Mbps”, “50 Mbps”, “15 Mbps”, and “1 Mbps” are provided.

The user selects the image quality while confirming the line speed displayed in line speed display area 152a. A selection candidate having higher image quality than the line speed displayed in line speed display area 152a may be made unselectable.

Then, if, for example, “50 Mbps” is selected in the quality selection area 152b (step S104: Yes), the connection unit 71 transmits information indicating the selected “50 Mbps” to the computer 5. In the computer 5, the display control unit 91 subtracts the selected image quality from the line speed to calculate a bit rate at which the meta information can be transmitted. Here, for example, “50 Mbps” is subtracted from “62 Mbps”, and “12 Mbps” is calculated as the bit rate at which the meta information can be transmitted.

Then, the display control unit 91 determines the content of the executable image processing on the basis of the calculated bit rate at which the meta information can be transmitted. Here, the display control unit 91 determines the content of the image processing to be executed so that the image processing is executed in descending order of priority according to the preset priority.

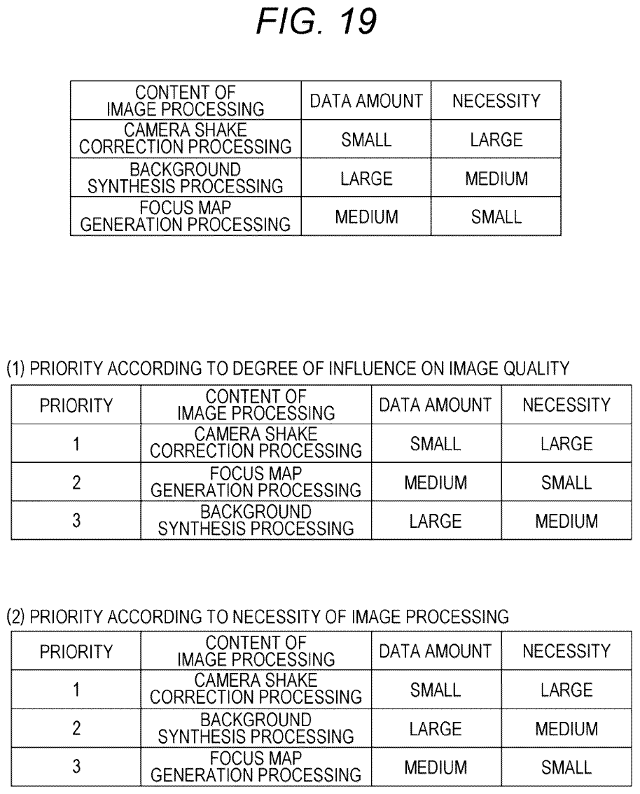

FIG. 19 is a view for explaining priority of the image processing. As illustrated in FIG. 19, only the motion information is used as the meta information in the camera shake correction processing, and thus, a data amount of the meta information necessary for executing the camera shake correction processing is small, but the necessity of indicating a degree of influence on appearance of the image is the highest.

Both the phase difference information and the motion information are used as the meta information in the background synthesis processing, and thus, a data amount of the meta information necessary for executing the background synthesis processing is large, but the necessity is lower than that of the camera shake correction processing.

Only the phase difference information is used as the meta information in the focus map generation processing, and thus, a data amount of the meta information necessary for executing the focus map generation processing is larger than that of the camera shake correction processing and smaller than that of the background synthesis processing, and the necessity is lower than that of the camera shake correction processing and the background synthesis processing.

Under such conditions, as illustrated in (1) of FIG. 19, for example, the priority may be set according to the degree of influence on the image quality, that is, the data amount of the meta information. In this case, as the data amount of the meta information is smaller, higher priority is set. Thus, the priority of the camera shake correction processing is the highest, the priority of the focus map generation processing is the next highest, and the priority of the background synthesis processing is the lowest.

Furthermore, as illustrated in (2) in FIG. 19, the priority may be set according to the necessity of the image processing. In this case, as the necessity is higher, higher priority is set. Thus, the priority of the camera shake correction processing is the highest, the priority of the background synthesis processing is the next highest, and the priority of the focus map generation processing is the lowest.

Furthermore, the user may set the priority.

The display control unit 91 determines the content of executable image processing on the basis of the priority as illustrated in FIG. 19 (step S105). For example, in a case where higher priority is set as the necessity is higher, the display control unit 91 first determines whether the motion information necessary for executing the camera shake correction processing with the highest priority can be transmitted.

Here, for example, it is assumed that a bit rate of the phase difference information is “10 Mbps” and a bit rate of the motion information is “5 Mbps”. Further, a bit rate at which the meta information can be transmitted is “12 Mbps”, and thus, it is determined that the motion information (5 Mbps) necessary for executing the camera shake correction processing can be transmitted. In other words, the display control unit 91 determines that the camera shake correction processing can be executed.

Next, the display control unit 91 determines whether the phase difference information and the motion information necessary for executing the background synthesis processing having the second highest priority after the camera shake correction processing can be transmitted. Further, a bit rate at which the meta information can be transmitted is “12 Mbps”, and thus, it is determined that the phase difference information and the motion information (10 Mbps+5 Mbps) necessary to perform the background synthesis processing cannot be transmitted.

In this way, if the content of the image processing to be executed is determined according to the priority, the display control unit 91 causes the determined content of the image processing to be identifiably displayed in the image processing content display area 152c of the image quality priority image 152.

This can allow the user to confirm the content of the image processing executable for the selected image quality. Then, if new image quality is selected in the quality selection area 152b, the display control unit 91 determines content of executable image processing again and displays the content in the image processing content display area 152c.

Then, if the determination button 152d of the image quality priority image 152 is operated by operation of the user via the operation unit 65 (step S106: Yes), the display control unit 91 transmits the image quality selected in the quality selection area 152b and the content of the image processing displayed in the image processing content display area 152c to the imaging device 2 as setting information in the mode determined on the mode setting screen 151 (the image quality priority mode or the image processing priority mode).

If the connection unit 71 receives the setting information from the computer 5, the setting saving unit 74 records the received setting information in the memory 62. In addition, the determination control unit 72 determines a type (the phase difference information, the motion information) of the meta information to be added to the image according to the content of the image processing indicated in the setting information, and the setting saving unit 74 records the type in the memory 62 as the setting information. As a result, the determination control unit 72 determines the mode, the image quality, the content of the image processing, and the type of the meta information to be added to the image (step S107).

Further, if the “image processing priority mode” is selected and determined on the mode setting screen 151 via the operation unit 65 (step S102: No), the connection unit 71 transmits information indicating this to the computer 5. In the computer 5, the display control unit 91 generates the image processing priority image 153 illustrated in FIG. 18 and transmits data of the image processing priority image 153 to the imaging device 2. As a result, in the imaging device 2, the image processing priority image 153 is displayed on the display unit 61.

The image processing priority image 153 includes a line speed display area 153a for displaying a current line speed, an image processing content display area 153b for selecting content of image processing to be executed, and an image quality selection area 153c for displaying image quality and a preview image.

The display control unit 91 displays the measured line speed (“61 Mbps” in the drawing) in the line speed display area 153a. This allows the user to confirm the current line speed in real time.

In the image processing content display area 153b, selection candidates of the content of the image processing are displayed, and check boxes for selecting one or more are displayed.

The user can select content of one or a plurality of kinds of image processing by checking a check box via the operation unit 65.

If the check box is checked (step S109: Yes), the connection unit 71 transmits information indicating the checked content of the image processing to the computer 5. In the computer 5, if the information indicating the checked content of the image processing is received, the display control unit 91 specifies a type of the meta information necessary for executing the checked content of the image processing. For example, if the camera shake correction processing and the background synthesis processing are checked, the display control unit 91 specifies that the meta information necessary for executing these kinds of image processing is the phase difference information and the motion information.

Then, the display control unit 91 calculates a bit rate necessary for transmitting the specified meta information, that is, the phase difference information and the motion information. Here, “10 Mbps”+“5 Mbps”=“15 Mbps” is calculated.

Thereafter, the display control unit 91 calculates image quality by subtracting the bit rate necessary for transmitting the specified meta information from the current line speed. Here, “61 Mbps”−“15 Mbps”=“46 Mbps” is calculated. After calculating the image quality, the display control unit 91 transmits information indicating the image quality to the imaging device 2.

In the imaging device 2, if the information indicating the image quality is received, the image signal processing unit 58 compresses and encodes the captured image to achieve the received image quality. Then, the determination control unit 72 displays the compression-encoded image in the image quality selection area 153c together with the image quality (step S110).

This allows the user to confirm the image quality when the selected image processing is executed.

Then, if the determination button 153d of the image processing priority image 153 is operated by operation of the user (step S106: Yes), the display control unit 91 transmits the image quality displayed in the image quality selection area 153c and the content of the image processing selected in the image processing content display area 153b to the imaging device 2 as the setting information in the mode determined on the mode setting screen 151 (the image quality priority mode or the image processing priority mode).

If the connection unit 71 receives the setting information from the computer 5, the setting saving unit 74 records the received setting information in the memory 62. In addition, the determination control unit 72 determines a type (the phase difference information, the motion information) of the meta information to be added to the image according to the content of the image processing indicated in the setting information, and the setting saving unit 74 records the type in the memory 62 as the setting information. As a result, the determination control unit 72 determines the mode, the image quality, the content of the image processing, and the type of the meta information to be added to the image (step S107).

If the image quality is determined in this manner, the determination control unit 72 controls the image signal processing unit 58 such that an image with the determined image quality is generated. In addition, the determination control unit 72 controls the meta information generation unit 73 to generate meta information for enabling execution of the determined content of image processing.

Then, if real-time distribution of the image is started (step S3), the image signal processing unit 58 compresses and encodes the image to achieve the determined image quality. Further, the meta information generation unit 73 generates the determined meta information.

The connection unit 71 adds the meta information to the generated image and transmits the image to the computer 5 (step S4). As a result, the image and the meta information are transmitted to the computer 5 within the line speed. In the computer 5, if the data acquisition unit 92 acquires the image and the meta information transmitted from the imaging device 2, the acquired image and meta information are stored in the recording medium 86.

In order to execute the determined content of the image processing, first, the image generation unit 93 analyzes the meta information stored in the recording medium 86, and determines whether the meta information for executing the determined content of the image processing is stored.

Then, in a case where the meta information for executing the determined content of the image processing is stored, the image generation unit 93 reads the image stored in the recording medium 86, executes the determined content of the image processing on the image using the meta information, and generates a corrected image (step S12).

The service provision unit 94 transmits the generated image subjected to the image processing to the device 141 that provides the image (step S13).

Note that the line speed between the imaging device 2 and the computer 5 may change during the live distribution service. For example, in a case where the line speed has decreased, the image quality determined first or the meta information necessary for executing the image processing of the determined content may not be transmitted.

Thus, the determination control unit 72 constantly monitors the line speed between the imaging device 2 and the computer 5, and in a case where the line speed has decreased and the image processing priority mode has been determined, in order to prioritize the image processing, calculates the image quality at which the image and the meta information can be transmitted without the meta information necessary for executing the image processing of the determined content being reduced. Then, the determination control unit 72 controls the image signal processing unit 58 so that the image is compressed and encoded with the calculated image quality.

As a result, the computer 5 can execute image processing of the determined content even if the line speed has decreased.

Furthermore, in a case where the line speed has decreased and the image quality priority mode has been determined, the determination control unit 72 reduces the meta information corresponding to the image processing with low priority so that the image and the meta information can be transmitted without decreasing the determined image quality in order to prioritize the image quality. Then, the determination control unit 72 controls the meta information generation unit 73 so as not to generate the reduced meta information.

As a result, even in a case where the line speed has decreased, the imaging device 2 can transmit the image and the meta information without delay while maintaining the image quality or the content of the image processing according to the mode selected by the user.

### [4.2. Automatic Editing Service]

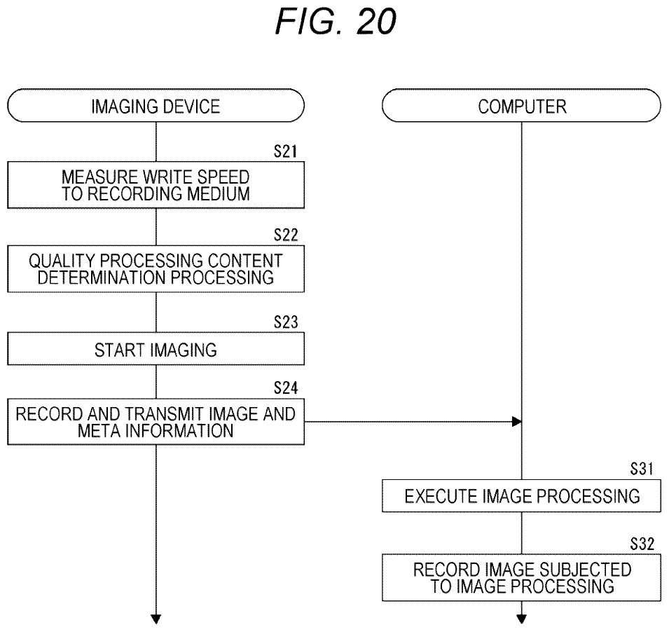

FIG. 20 is a view indicating a sequence chart of the automatic editing service. In the automatic editing service, if imaging is started by the imaging device 2, an image and meta information are recorded in the recording medium 60. Then, the image and the meta information stored in the recording medium 60 are transmitted to the computer 5 after the end of the imaging, and the computer 5 performs image processing on the image on the basis of the meta information.

Note that in the automatic editing service, the content of the image processing to be executed may be determined in advance, or the content of the image processing to be executed does not have to be determined. In a case where the content of the image processing to be executed is determined in advance, meta information necessary for executing the image processing is provided to the image. In a case where the content of the image processing to be executed is not determined, the meta information selected by the user may be provided to the image, or all types of meta information may be provided. Hereinafter, a case where the meta information to be provided to the image is the phase difference information will be described as an example. Further, it is assumed that in the automatic editing service, only the main line clip (image and meta information) is recorded.

Here, the recording medium 60 has a different write speed for each recording medium. For example, in the recording medium 60 having a high write speed, it is possible to record the whole in real time without reducing a data amount (bit rate) of the image and the meta information. On the other hand, in the recording medium 60 having a low write speed, there is a case where recording cannot be performed in real time without reducing a data amount of the image and the meta information.

Thus, in the automatic editing service, the determination control unit 72 determines a format (full phase difference information or light phase difference information) of the meta information to be added to the image according to the write speed of the recording medium 60. Further, the determination control unit 72 also determines image quality according to the write speed of the recording medium 60.

First, for example, if the automatic editing service is started according to the operation on the operation unit 65 of the imaging device 2, the determination control unit 72 of the imaging device 2 writes a predetermined amount of data in the recording medium 60 and measures a period for writing the data, thereby measuring the write speed to the recording medium 60 (step S21).

Subsequently, the determination control unit 72 displays a mode setting screen 151 as illustrated in FIG. 15 on the display unit 61, and selects the image quality priority mode or the image processing priority mode according to operation of the user via the operation unit 65.

In a case where the measured write speed is higher than or equal to a predetermined value, the determination control unit 72 determines the image quality to be at a predetermined bit rate regardless of which of the image quality priority mode and the image processing priority mode is selected, and determines to provide the full phase difference information. Note that the predetermined value is set to a value at which all images can be recorded in real time even if images are recorded at a predetermined bit rate and full phase difference information is recorded. In addition, the predetermined bit rate may be set by the user in advance, or may be determined to an arbitrary bit rate.

On the other hand, in a case where the measured write speed is less than the predetermined value and the image processing priority mode is selected, the determination control unit 72 determines to provide the full phase difference information. In addition, the determination control unit 72 calculates the image quality that can be written by subtracting the speed at which the full phase difference information is written from the measured write speed. Then, the determination control unit 72 determines the calculated image quality.

In a case where the measured write speed is less than the predetermined value and the image quality priority mode is selected, the determination control unit 72 determines to provide the light phase difference information. In addition, the determination control unit 72 calculates the image quality that can be written by subtracting the speed at which the light phase difference information is written from the measured write speed. Then, the determination control unit 72 determines the calculated image quality.

In this manner, the determination control unit 72 determines the image quality and a format of the meta information (phase difference information) to be provided on the basis of the write speed to the recording medium 60 and the mode selected by the user. The setting saving unit 74 records the determined image quality and the format of the meta information (phase difference information) to be provided in the memory 62.

Note that, here, the content of the image processing to be performed in the automatic editing mode may be selected, the determination to provide the meta information necessary for executing the image processing of the content may be performed, and the image quality may be determined according to the determination.

Thereafter, the determination control unit 72 controls the image signal processing unit 58 such that an image is generated with the determined image quality. Further, the determination control unit 72 controls the meta information generation unit 73 to generate the determined meta information (Step S22).

Then, if imaging is started (step S23), the image signal processing unit 58 compresses and encodes the image to achieve the determined image quality. Further, the meta information generation unit 73 generates the determined meta information.

Then, the recording unit 59 adds the meta information to the generated image and records the image in the recording medium 60.

Then, if the imaging is completed, for example, the recording medium 60 is detached from the imaging device 2 and attached to the computer 5 as the recording medium 86, whereby the image and the meta information are transmitted to the computer 5 (step S24). Note that the image and the meta information recorded in the recording medium 60 may be transmitted to the computer 5 via the smartphone 4 so that the image and the meta information are transmitted to the computer 5.

Thereafter, in the computer 5, the data acquisition unit 92 acquires the transmitted image and meta information and records the acquired image and meta information in the recording medium 86. Thereafter, the image generation unit 93 determines whether the image processing of the determined content can be executed by analyzing the meta information stored in the recording medium 86. Then, in a case where the meta information for executing the image processing of the determined content is stored, the image generation unit 93 reads the image stored in the recording medium 86 and executes the image processing of the determined content using the meta information on the image. Then, the image subjected to the image processing is recorded in the recording medium 86, for example, and is provided to the user (step S32).

### [4.3. Service for News Report]

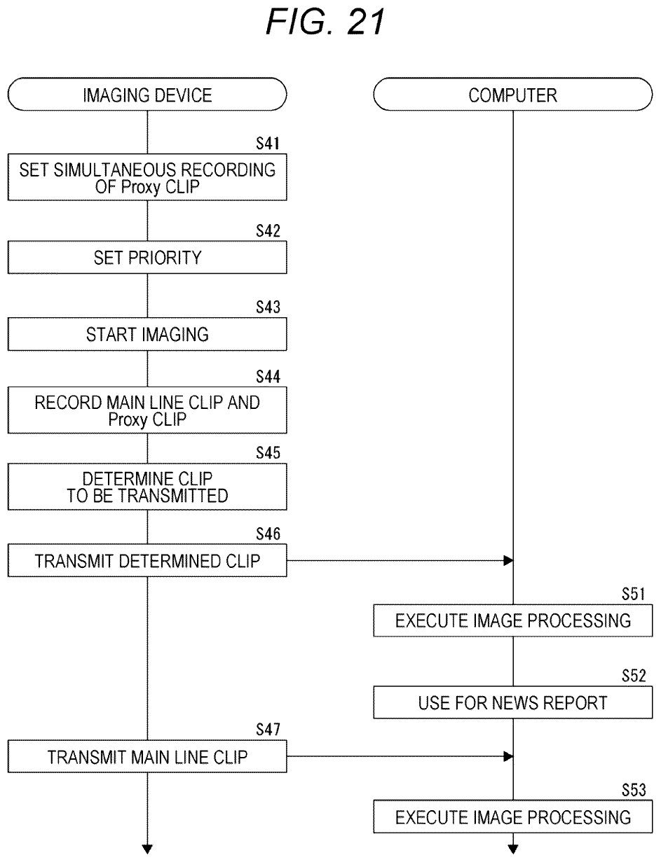

FIG. 21 is a sequence chart indicating flow of a service for news report. In a news program, or the like, it may be required to quickly use an image captured by the imaging device 2 for news report. In such a case, if image processing is executed after the main line clip captured by the imaging device 2 is transmitted to the computer 5, it takes time to transmit data, and there is a possibility that the main line clip cannot be used for news report early.

Thus, in the service for news report, if imaging is started by the imaging device 2, the proxy clip can be recorded in the recording medium 60 in addition to the main line clip, and the proxy clip having a low bit rate is transmitted to the computer 5 prior to the main line clip, so that a data transmission period can be shortened, and the proxy clip can be used for news report early.

Note that, in the service for news report, background blurring processing is executed as content of image processing.

If the service for news report is started, the determination control unit 72 causes the user to select (set) whether or not to perform simultaneous recording of the proxy clip in addition to the main line clip (step S41). Here, for example, the determination control unit 72 may display a UI screen for selecting whether or not to perform simultaneous recording of the proxy clip on the display unit 61 and may cause the user to perform selection by operation of the user via the operation unit 65.

In addition, the determination control unit 72 causes the user to select (set) which of the main line clip and the proxy clip is to be preferentially transmitted to the computer 5 or the automatically determined clip is to be preferentially transmitted to the computer 5 (step S42). Here, the determination control unit 72 may display, on the display unit 61, a UI screen for selecting, for example, which of the main line clip and the proxy clip is to be preferentially transmitted to the computer 5 or the automatically determined clip is to be preferentially transmitted to the computer 5, and may cause the user to perform selection by operation of the user via the operation unit 65.

Furthermore, in a case where the automatically determined clip is to be preferentially transmitted to the computer 5, the determination control unit 72 causes the user to select a transmission period (within how many minutes the transmission is desired to be completed).

In this way, if whether or not the proxy clip is recorded and the transmission priority order of the main line clip and the proxy clip are set, the setting saving unit 74 saves the setting information in the memory 62.

Thereafter, if imaging is started (step S43), the image signal processing unit 58 compresses and encodes the image so as to achieve the image quality of the main line clip determined in advance. Furthermore, in a case where the setting for recording the proxy clip is made, the image signal processing unit 58 compresses and encodes the image so as to achieve the image quality of the proxy clip determined in advance.

The meta information generation unit 73 generates meta information including at least phase difference information necessary for executing the background blurring processing.

As a result, the main line clip and the proxy clip are generated in the imaging device 2.

The recording unit 59 records the generated main line clip and proxy clip in the recording medium 60 (step S44).

Thereafter, if the imaging is completed, a clip to be transmitted to the computer 5 is determined on the basis of the transmission priority order (step S45). Specifically, in a case where the setting for preferentially transmitting the main line clip is made, the connection unit 71 determines to transmit the main line clip. Furthermore, in a case where the setting for preferentially transmitting the proxy clip is made, the connection unit 71 determines to transmit the proxy clip.

Here, when the main line clip or the proxy clip is transmitted to the computer 5, if imaging is newly started by the imaging device 2 and the main line clip and the proxy clip are newly recorded in the recording medium 60, a speed of reading the main line clip or the proxy clip to be transmitted from the recording medium 60 decreases.

Thus, in a case where the automatically determined clip is preferentially transmitted to the computer 5, the connection unit 71 measures a read speed of the recording medium 60 and the line speed with the computer 5. Then, an amount of data that can be transmitted within the selected period is calculated at the measured read speed and line speed. Then, in a case where the main line clip is equal to or less than the calculated amount of data, the connection unit 71 determines to transmit the main line clip. On the other hand, in a case where the main line clip is larger than the calculated amount of data, the connection unit 71 determines to transmit the proxy clip.

Then, the connection unit 71 transmits the determined main line clip or proxy clip to the computer 5 (step S46).

Thereafter, in the computer 5, the data acquisition unit 92 acquires the transmitted main line clip or proxy clip and records the main line clip or proxy clip in the recording medium 86. The image generation unit 93 determines whether the image processing (background blurring processing) of the determined content can be executed by analyzing the meta information stored in recording medium 86. Then, in a case where the meta information for executing the image processing of the determined content is stored, the image generation unit 93 reads the image stored in the recording medium 86, and executes the image processing of the determined content using the meta information on the image (step S51). Then, the image subjected to the image processing is used for the news report (step S52).

In a case where the proxy clip is transmitted in step S46, the connection unit 71 transmits the main line clip to the computer 5 when the main line clip can be transmitted (step S47). Then, in the computer 5, the data acquisition unit 92 receives the main line clip and records the main line clip in the recording medium 86. Furthermore, the image generation unit 93 reads the image stored in the recording medium 86, and executes image processing of the content determined using the meta information on the image (step S53). Then, the image subjected to the image processing is used for news report later.

Note that in a case where the main line clip is transmitted in step S46, the processing in steps S47 and S53 is omitted.

### 5. Meta Information Data Amount Reduction

In the service described above, by controlling the type (the phase difference information, the motion information) or format (the full phase difference information, the light phase difference information) of the meta information to be added to the image, the meta information can be recorded in the recording medium 60 together with the image, and the meta information can be transmitted to the computer 5 together with the image.

However, the determination control unit 72 may perform the control regarding provision by changing not only the type and format of the meta information but also an addition frequency, an addition timing, a data amount compression method, and the like.

For example, the phase difference information includes a defocus amount for each phase difference detection pixel 55b. Thus, the determination control unit 72 may regard the phase difference information as image data and compress the phase difference information by a method similar to the image data compression method.

As a method of compressing the phase difference information, lossy compression or lossless compression may be performed on the phase difference information for each frame.

In addition, among consecutive frames, key frames may be left as they are, and frames between key frames may be subjected to data compression by taking a difference from the key frames.

Furthermore, data compression may be performed by cutting out a characteristic part of the frame (for example, a part where the subject is a person).

Furthermore, a maximum value of the defocus amount may be detected for each certain section, and data compression may be performed by expressing the defocus amount for each phase difference detection pixel 55b by a difference value from the maximum value.

Furthermore, the determination control unit 72 may thin the addition frequency of the phase difference information and the motion information to be an appropriate frequency instead of adding the phase difference information and the motion information for each frame of the image.

In addition, concerning the addition timing of the phase difference information and the motion information, the determination control unit 72 may record or transmit the meta information only in a necessary section such as when the line speed does not decrease.

Furthermore, the determination control unit 72 may carefully select necessary meta information and record or transmit the necessary meta information.

### 6. Modifications

Note that, the embodiment is not limited to the specific examples described above, and may have configurations as various modifications.

In the above embodiment, a case where the connection unit 71, the determination control unit 72, the meta information generation unit 73, and the setting saving unit 74 are provided in the imaging device 2 has been described. However, these functional units may be provided in the smartphone 4 or the computer 5.

Furthermore, in the above embodiment, a case where the display control unit 91, the data acquisition unit 92, the image generation unit 93, and the service provision unit 94 are provided in the computer 5 has been described. However, these functional units may be provided in the imaging device 2 or the smartphone 4.

In the above embodiment, the phase difference information and the motion information are included as the meta information. However, the meta information may include at least one of the phase difference information or the motion information. In other words, the determination control unit 72 may perform control regarding provision of the meta information including at least one of the phase difference information based on a signal output from the phase difference detection pixel 55b or the motion information regarding the motion of the imaging device 2 to the image according to the content of image processing to be executed on the image obtained by the imaging device 2.

Further, in the above embodiment, the image quality priority mode or the image processing priority mode is selected in the live distribution service, and the content of the selected mode is preferentially determined. However, in the live distribution service, the user may select each of the image quality and the content of the image processing.

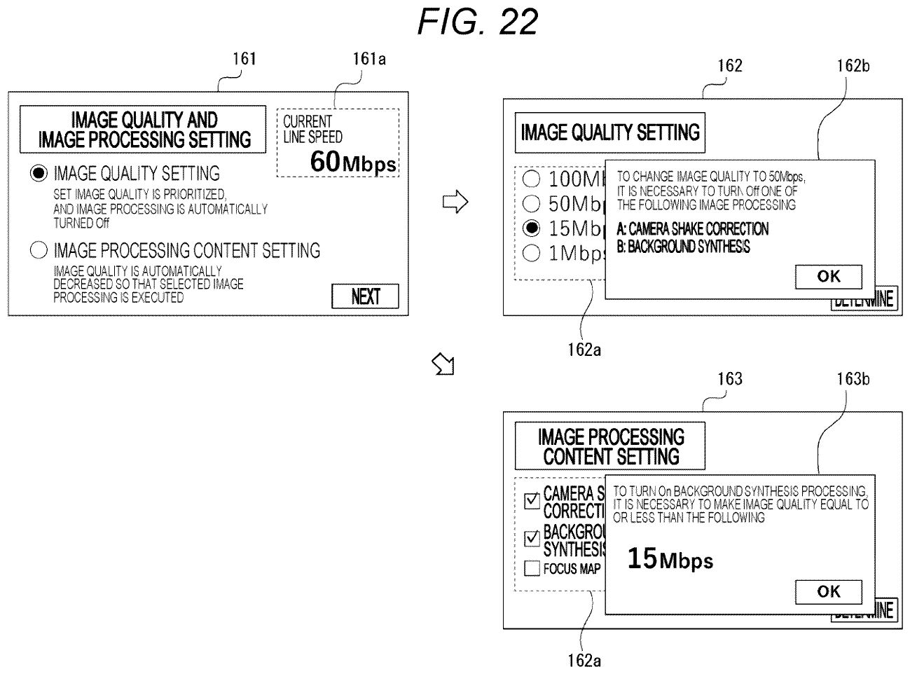

For example, as illustrated in FIG. 22, the display control unit 91 displays a quality content setting screen 161 on the display unit 61. On the quality content setting screen 161, a radio button for selecting the image quality setting screen 162 or an image processing content setting screen 163 is displayed. Further, the quality content setting screen 161 is provided with a line speed display area 161a for displaying the current line speed (“60 Mbps” in the drawing).

If the image quality setting screen 162 is selected on the quality content setting screen 161, the display control unit 91 causes the display unit 61 to display the image quality setting screen 162. The image quality setting screen 162 is provided with a quality selection area 162a for selecting image quality. In a case where the image quality is changed from “15 Mbps” to “50 Mbps”, for example, by operation of the user on the quality selection area 162a, a pop-up 162b for making a notification that the bit rate at which the meta information is transmitted decreases due to the increase in the image quality, and that the meta information for executing a part of the image processing that is being set (for example, camera shake correction processing and background synthesis processing) cannot be transmitted is displayed on the display unit 61.

If the image processing content setting screen 163 is selected on the quality content setting screen 161, the display control unit 91 causes the display unit 61 to display the image processing content setting screen 163. The image processing content setting screen 163 is provided with an image processing content display area 163a for selecting the content of image processing. In a case where the background synthesis processing is added by operation of the user on the image processing content display area 163a, for example, the bit rate of the meta information is increased, the image quality is degraded, and the image with the image quality that is being set may not be able to be transmitted. In this case, the display control unit 91 causes the display unit 61 to display a pop-up 163b for making a notification of image quality with which transmission can be performed.

As a result, in a case where one of the image quality and the content of the image processing is changed, it is possible to make a notification as to how to change the other.

### 7. Summary of Embodiment

As described above, the information processing device (imaging device 2) of the embodiment includes the control unit (determination control unit 72) that performs control regarding provision of the meta information including at least one of the phase difference information based on the signal output from the phase difference detection pixel 55b or the motion information regarding the motion of the imaging device 2 to the image according to the content of the image processing to be executed on the image obtained by the imaging device 2.

As a result, in the imaging device 2, for example, it is possible to reduce a possibility that the image and the meta information cannot be transmitted to the computer 5 or a possibility that the image and the meta information cannot be recorded in the recording medium 60.

Thus, the imaging device 2 can appropriately provide the meta information according to the image processing to be performed on the image.

Furthermore, the control unit (determination control unit 72) performs control regarding addition of the meta information to the image according to a service in which the image subjected to the image processing is provided.

Here, the content of the image processing to be executed is different for each service to be provided. Thus, the imaging device 2 performs the control regarding provision of the meta information according to the service to be provided, so that the optimum meta information can be provided according to the content of the image processing to be executed in the service.

Furthermore, the control unit (determination control unit 72) determines the image quality or the content of the image processing, and performs control regarding addition of the meta information to the image according to the determined image quality and the content of the image processing.

As a result, the imaging device 2 can determine the content of executable image processing while giving priority to the determined image quality or can determine the image quality while giving priority to the determined content of image processing.

In other words, in the imaging device 2, one of the image quality and the content of the image processing can be preferentially determined, and the other can be determined correspondingly.

The control unit (determination control unit 72) determines at least one of the type of the meta information to be added to the image, the addition frequency of the meta information, the addition timing of the meta information, or the format of the meta information as the control regarding addition of the meta information to the image.

This can reduce a data amount of the meta information to be added to the image.

The service includes a live distribution service for distributing an image subjected to the image processing to other devices.

As a result, an image obtained by executing the image processing on the image obtained by the imaging device 2 can be distributed to the other devices 141 in substantially real time.

The information processing device includes a display control unit 91 that causes a display unit to display a UI screen for determining image quality and content of the image processing.

As a result, the user can determine the image quality and the content of the image processing according to the UI screen. Thus, the user can easily determine the image quality and the content of the image processing.

The control unit (determination control unit 72) determines image quality according to the determined content of the image processing.

As a result, in the imaging device 2, the meta information necessary for performing the image processing of the determined content can be provided to the image, and the image quality can be determined so that the image can be transmitted to the computer 5 or recorded in the recording medium 60 in time.

The control unit (determination control unit 72) determines the content of image processing to be executed according to predetermined priority.

Consequently, the optimum meta information can be provided to the image according to a degree of influence on the image quality and the necessity of the image processing.

The service includes an automatic editing service for executing image processing on an image recorded in the recording medium 60.

As a result, the image processing can be automatically executed on the image obtained by the imaging device 2. In other words, the image processing can be executed without forcing the user to perform bothersome operation.

The control unit (determination control unit 72) determines image quality on the basis of the write speed of the recording medium 60.

This makes it possible to reduce a possibility that the image and the meta information cannot be recorded in the recording medium 60.

The control unit (determination control unit 72) performs control regarding provision of the meta information on the basis of the write speed of the recording medium 60.

This makes it possible to reduce a possibility that the image and the meta information cannot be recorded in the recording medium 60.

The format of the meta information includes full meta information including all pieces of information and light meta information in which some pieces of information are excluded.

As a result, the meta information can be recorded so that the meta information can be transmitted to the computer 5 or recorded in the recording medium 60 in time.

The format of the phase difference information includes full phase difference information including a focus shift amount for each phase difference detection pixel 55b and auxiliary information to be used when the shift amount is calculated, and light phase difference information which includes the focus shift amount for each phase difference detection pixel and in which the auxiliary information is excluded.

As a result, the phase difference information can be recorded so as to be transmitted to the computer 5 or recorded in the recording medium 60 in time.

The service includes a service for news report for executing the image processing on one of a main line clip in which the meta information is added to a high-quality image with predetermined image quality and a proxy clip in which the meta information is added to a low-quality image with image quality lower than that of the high-quality image.

As a result, the transmission period can be shortened by transmitting the proxy clip to the computer 5, and the image subjected to the image processing can be used for news report early.

The information processing device (imaging device 2) includes the connection unit 71 that transmits the proxy clip to other devices in preference to the main line clip.

As a result, the transmission period can be shortened by transmitting the proxy clip to the computer 5, and the image subjected to the image processing can be used for news report early. Furthermore, in news report later, the image of the main line clip subjected to the image processing can be used.

The transmission speed is made varied depending on whether or not the imaging device 2 is performing imaging.

Consequently, the image and the meta information can be optimally read from the recording medium 60.

The control unit (determination control unit 72) causes the phase difference information to be provided in a case of any of background synthesis processing of synthesizing another background with the image, background blurring processing of blurring the background of the image, and focus map generation processing of generating a focus map.

As a result, the background synthesis processing, the background blurring processing, and the focus map generation processing can be executed on the basis of the phase difference information.

The control unit (determination control unit 72) causes the motion information to be provided in a case of any of camera shake correction processing of reducing camera shake of the image, horizontal correction processing of correcting horizontal of the image, and background synthesis processing of synthesizing another background with the image.

As a result, the camera shake correction processing, the horizontal correction processing, and the background synthesis processing can be executed on the basis of the motion information.

Furthermore, in the information processing method, control regarding provision of meta information including at least one of phase difference information based on a signal output from the phase difference detection pixel 55b or motion information regarding motion of the imaging device 2 to an image is performed according to content of image processing to be executed on the image obtained by the imaging device 2.

Note that, the effects described in the present specification are merely examples and are not limited, and other effects may be provided.

### 8. Present Technology

Note that the present technology can also have the following configurations.

(1)

An information processing device including:
a control unit that performs control regarding provision of meta information to an image obtained by an imaging device, the meta information including at least one of phase difference information based on a signal output from a phase difference detection pixel or motion information regarding motion of the imaging device, in accordance with content of image processing to be executed on the image.
   (2)

The information processing device according to (1), in which
the control unit performs control regarding addition of the meta information to the image according to a service in which the image subjected to the image processing is provided.
   (3)

The information processing device according to (1) or (2), in which
the control unit determines image quality or content of the image processing, and performs control regarding addition of the meta information to the image according to the determined image quality or content of the image processing.
   (4)

The information processing device according to any one of (1) to (3), in which
the control unit determines at least one of a type of the meta information to be provided to the image, an addition frequency of the meta information, an addition timing of the meta information, or a format of the meta information as the control regarding addition of the meta information to the image.
   (5)

The information processing device according to (2), in which
the service includes a live distribution service for distributing the image subjected to the image processing to another device.
   (6)

The information processing device according to any one of (1) to (5), further including
a display control unit that causes a display unit to display a UI screen for determining image quality and content of the image processing.
   (7)

The information processing device according to (6), in which
the control unit determines the image quality according to the determined content of the image processing.
   (8)

The information processing device according to any one of (1) to (7), in which
the control unit determines the content of the image processing to be executed according to predetermined priority.
   (9)

The information processing device according to (8), in which
the priority is set according to a degree of influence on image quality or necessity of the image processing.
   (10)

The information processing device according to (2), in which
the service includes an automatic editing service for executing the image processing on an image recorded in a recording medium.
   (11)

The information processing device according to (10), in which
the control unit determines image quality on the basis of a write speed of the recording medium.
   (12)

The information processing device according to (10) or (11), in which
the control unit performs control regarding provision of the meta information on the basis of a write speed of the recording medium.
   (13)

The information processing device according to (4), in which
the format of the meta information includes full meta information including all pieces of information and light meta information in which some pieces of information are excluded.
   (14)

The information processing device according to (13), in which
the format of the phase difference information includes full phase difference information including a focus shift amount for each phase difference detection pixel and auxiliary information to be used in calculating the shift amount, and light phase difference information which includes a focus shift amount for each phase difference detection pixel and in which the auxiliary information is excluded.
   (15)

The information processing device according to (2), in which
the service includes a service for news report for executing the image processing on either a main line clip in which the meta information is added to a high-quality image with predetermined image quality or a proxy clip in which the meta information is added to a low-quality image with image quality lower than that of the high-quality image.
   (16)

The information processing device according to (15), further including
a connection unit that transmits the proxy clip to another device in preference to the main line clip.
   (17)

The information processing device according to (15) or (16), in which
a transmission speed is made varied depending on whether or not the imaging device is performing imaging.
   (18)

The information processing device according to any one of (1) to (17), in which
the control unit causes the phase difference information to be provided in a case of any of background synthesis processing of synthesizing another background with the image, background blurring processing of blurring a background of the image, and focus map generation processing of generating a focus map.
   (19)

The information processing device according to any one of (1) to (18), in which
the control unit causes the motion information to be provided in a case of any of camera shake correction processing of reducing camera shake of the image, horizontal correction processing of correcting horizontal of the image, and background synthesis processing of synthesizing another background with the image.
   (20)

An information processing method including:
performing control regarding provision of meta information to an image obtained by an imaging device, the meta information including at least one of phase difference information based on a signal output from a phase difference detection pixel or motion information regarding motion of the imaging device, in accordance with content of image processing to be executed on the image.

### REFERENCE SIGNS LIST

1 Meta information provision system
17a Motion sensor
2 Imaging device
5 Computer
55 Imaging element
55a RGB pixel
55b Phase difference detection pixel
60 Recording medium
71 Connection unit
72 Determination control unit
73 Meta information generation unit
74 Setting saving unit
91 Display control unit
92 Data acquisition unit
93 Image generation unit
94 Service provision unit

1. An information processing device comprising:
a control unit that performs control regarding provision of meta information to an image obtained by an imaging device, the meta information including at least one of phase difference information based on a signal output from a phase difference detection pixel or motion information regarding motion of the imaging device, in accordance with content of image processing to be executed on the image.

2. The information processing device according to claim 1, wherein
the control unit performs control regarding addition of the meta information to the image according to a service in which the image subjected to the image processing is provided.

3. The information processing device according to claim 1, wherein
the control unit determines image quality or content of the image processing, and performs control regarding addition of the meta information to the image according to the determined image quality or content of the image processing.

4. The information processing device according to claim 1, wherein
the control unit determines at least one of a type of the meta information to be added to the image, an addition frequency of the meta information, an addition timing of the meta information, or a format of the meta information as the control regarding addition of the meta information to the image.

5. The information processing device according to claim 2, wherein
the service includes a live distribution service for distributing the image subjected to the image processing to another device.

6. The information processing device according to claim 1, further comprising
a display control unit that causes a display unit to display a UI screen for determining image quality and content of the image processing.

7. The information processing device according to claim 6, wherein
the control unit determines the image quality according to the determined content of the image processing.

8. The information processing device according to claim 1, wherein
the control unit determines the content of the image processing to be executed according to predetermined priority.

9. The information processing device according to claim 8, wherein
the priority is set according to a degree of influence on image quality or necessity of the image processing.

10. The information processing device according to claim 2, wherein
the service includes an automatic editing service for executing the image processing on an image recorded in a recording medium.

11. The information processing device according to claim 10, wherein
the control unit determines image quality on a basis of a write speed of the recording medium.

12. The information processing device according to claim 10, wherein
the control unit performs control regarding provision of the meta information on a basis of a write speed of the recording medium.

13. The information processing device according to claim 4, wherein
the format of the meta information includes full meta information including all pieces of information and light meta information in which some pieces of information are excluded.

14. The information processing device according to claim 13, wherein
the format of the phase difference information includes full phase difference information including a focus shift amount for each phase difference detection pixel and auxiliary information to be used in calculating the shift amount, and light phase difference information which includes a focus shift amount for each phase difference detection pixel and in which the auxiliary information is excluded.

15. The information processing device according to claim 2, wherein
the service includes a service for news report for executing the image processing on either a main line clip in which the meta information is added to a high-quality image with predetermined image quality or a proxy clip in which the meta information is added to a low-quality image with image quality lower than that of the high-quality image.

16. The information processing device according to claim 15, further comprising
a connection unit that transmits the proxy clip to another device in preference to the main line clip.

17. The information processing device according to claim 15, wherein
a transmission speed is made varied depending on whether or not the imaging device is performing imaging.

18. The information processing device according to claim 1, wherein
the control unit causes the phase difference information to be provided in a case of any of background synthesis processing of synthesizing another background with the image, background blurring processing of blurring a background of the image, and focus map generation processing of generating a focus map.

19. The information processing device according to claim 1, wherein
the control unit causes the motion information to be provided in a case of any of camera shake correction processing of reducing camera shake of the image, horizontal correction processing of correcting horizontal of the image, and background synthesis processing of synthesizing another background with the image.

20. An information processing method comprising:
performing control regarding provision of meta information to an image obtained by an imaging device, the meta information including at least one of phase difference information based on a signal output from a phase difference detection pixel or motion information regarding motion of the imaging device, in accordance with content of image processing to be executed on the image.
